(19) United States
(12) Patent Application Publication
(10) Pub. No.: US 2004/0210529 A1
(43) Pub. Date: Oct. 21, 2004

(54) Method of making a monetary transaction between a customer and a merchant

(75) Inventor: E-Young Wu, Taipei (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Global On Line Corp.

(21) Appl. No.: 10/622,298

(22) Filed: Jul. 17, 2003

(30) Foreign Application Priority Data
Apr. 15, 2003 (TW) 092108724

(51) Int. Cl. G06F 17/60

(52) U.S. Cl. 705/42

(57) ABSTRACT

In a method of making a monetary transaction between a customer and a merchant, a processing terminal of the merchant is operated to establish a connection with a mobile terminal of the customer and to request for virtual currency information issued by a financial institution and stored in the mobile terminal. Upon receipt of the virtual currency information from the mobile terminal, the processing terminal issues an authentication request to the financial institution. The monetary transaction is completed upon receipt of an authorization response from the financial institution.

### CROSS-REFERENCE TO RELATED APPLICATION

This application claims priority of Taiwanese Application No. 092108724, filed on Apr. 15, 2003.

### BACKGROUND OF THE INVENTION

1. Field of the Invention

The invention relates to a method of making a monetary transaction, more particularly to a method of making a monetary transaction between a customer and a merchant.

2. Description of the Related Art

Currently, customers are able to conduct a monetary transaction by means of a plastic currency, such as a credit card, a pre-paid card, a bank card, etc.

The plastic currency described above has a magnetic strip containing virtual currency information issued by a financial institution and associated with the owner of the card. During payment for a merchandise, the virtual currency information stored in the magnetic strip of the card of a customer must be read by a card reader of a merchant. The virtual currency information read by the card reader is then transmitted to the financial institution. Upon receipt of an authorization response, which is associated with an authentication request issued by the merchant, from the financial institution, the merchant generates a transaction receipt for the customer.

However, during reading of the virtual currency information associated with the customer, unauthorized copying of the virtual currency information may occur, which can result in losses to the customer, the merchant and the financial institution.

### SUMMARY OF THE INVENTION

Therefore, the object of the present invention is to provide a method of making a monetary transaction between a customer and a merchant that can provide relatively high security during the conduct of a monetary transaction.

According to one aspect of the present invention, there is provided a method of making a monetary transaction between a customer and a merchant. The method comprises the steps of:

a) operating a processing terminal of the merchant to establish a connection with a mobile terminal of the customer and to request for virtual currency information issued by a financial institution and stored in the mobile terminal;

b) upon receipt of the virtual currency information from the mobile terminal, enabling the processing terminal to issue an authentication request to the financial institution; and

c) completing the monetary transaction upon receipt of an authorization response from the financial institution.

According to another aspect of the present invention, there is provided a method of making a monetary transaction between a customer and a merchant. The method comprises the steps of:

a) storing virtual currency information issued by a financial institution in a mobile terminal of the customer;

b) inputting transaction information into a processing terminal of the merchant;

c) enabling the processing terminal to establish a connection with the mobile terminal and to request for the virtual currency information stored in the mobile terminal;

d) enabling the mobile terminal to transmit the virtual currency information to the processing terminal upon receipt of the request from the processing terminal;

e) upon receipt of the virtual currency information from the mobile terminal, enabling the processing terminal to issue an authentication request to the financial institution;

f) enabling the financial institution to process the authentication request from the processing terminal and to issue an authorization response to the processing terminal in accordance with processing result of the authentication request; and

g) enabling the processing terminal to complete the monetary transaction upon receipt of the authorization response from the financial institution.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view illustrating a system that is configured according to the preferred embodiment of a method of making a monetary transaction between a customer and a merchant of the present invention;

FIG. 2 is a flow chart illustrating how the system is configured to make the monetary transaction in accordance with the method of the preferred embodiment; and

FIG. 3 is a flow chart illustrating how a mobile terminal of the customer is configured to transmit virtual currency information in accordance with the method of the preferred embodiment.

### DETAILED DESCRIPTION OF THE PREFERRED EMBODIMENT

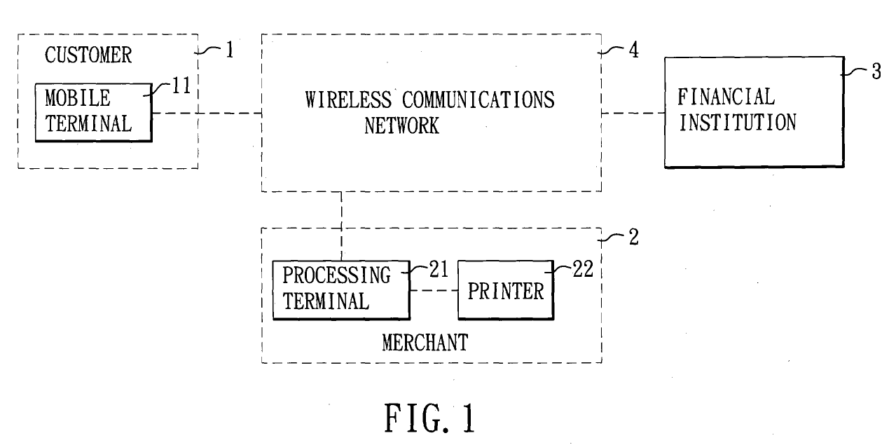

FIG. 1 illustrates a system that is configured according to the preferred embodiment of a method of making a monetary transaction between a customer and a merchant 2 of the present invention. In this embodiment, the system includes the customer 1, the merchant 2, and a financial institution 3. The customer 1 has a mobile terminal 11, such as a mobile phone, a personal digital assistant or a palm computer. The mobile terminal 11 is installed with a subscriber identification module (SIM) card (not shown) for wireless communication with a wireless communications network. The merchant 2 has a processing terminal 21 capable of communicating with the mobile terminal 11 and the financial institution 3, and a printer 22 coupled to the processing terminal 21.

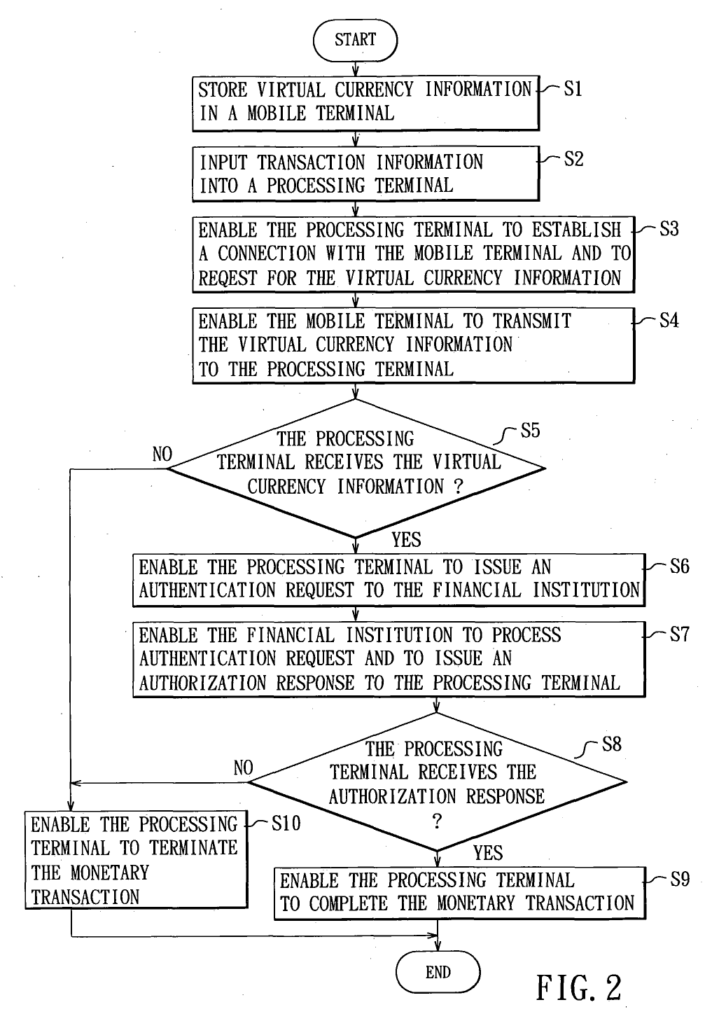

Referring to FIG. 2, there is shown a flow chart to illustrate how a monetary transaction is made between the merchant 2 and the customer 1 in accordance with the method of the preferred embodiment. In step S1, virtual currency information issued by the financial institution 3 is stored in the SIM card installed in the mobile terminal 11. In this embodiment, the virtual currency information includes an account number, validity date, etc. In step S2, transaction information is inputted into the processing terminal 21 of the merchant 2. In this embodiment, the transaction information includes a transaction amount, such as name and price of a merchandise, transaction date, etc. The transaction information further includes a telephone number associated with the mobile terminal 11. In step S3, the processing terminal 21 is configured to establish a connection with the mobile terminal 11 via a wireless communications network 4, such as a general packet radio service (GPRS) system, according to the X.25 communications protocol to transmit the transaction amount to the mobile terminal 11, and to request for the virtual current information stored in the mobile terminal 11. In this embodiment, the processing terminal 21 is configured to dial the telephone number associated with the mobile terminal 11. In step S4, the mobile terminal 11 is configured to transmit the virtual currency information to the processing terminal 21 upon receipt of the request from the processing terminal 21. In step S5, the processing terminal 21 is configured to detect whether the virtual currency information from the mobile terminal 11 has been received thereby. In step S6, upon receipt of the virtual currency information from the mobile terminal 11, the processing terminal 21 is configured to issue an authentication request to the financial institution 3. At the same time, the transaction amount of the transaction information inputted in step S2 is transmitted to the financial institution 3 by establishing a wired or wireless communications link with the financial institution 3. When the processing terminal 21 fails to receive the virtual currency information from the mobile terminal 11, the flow proceeds to step S10. In step 10, the processing terminal 21 is configured to terminate the monetary transaction. In step S7, the financial institution 3 is configured to process the authentication request from the processing terminal 21 in a conventional manner and to issue an authorization response to the processing terminal 21 in accordance with processing result of the authentication request. In step S8, the processing terminal 21 is configured to detect whether the authorization response from the financial institution 3 has been received thereby. In step S9, upon receipt of the authorization response from the financial institution 3, the processing terminal 21 is configured to complete the monetary transaction and to generate a transaction receipt. In this embodiment, the transaction receipt is printed by the printer 32, which is coupled to the processing terminal 21 through conventional wired or wireless devices. The flow proceeds to step S10 when the processing terminal 21 fails to receive the authorization response from the financial institution 3.

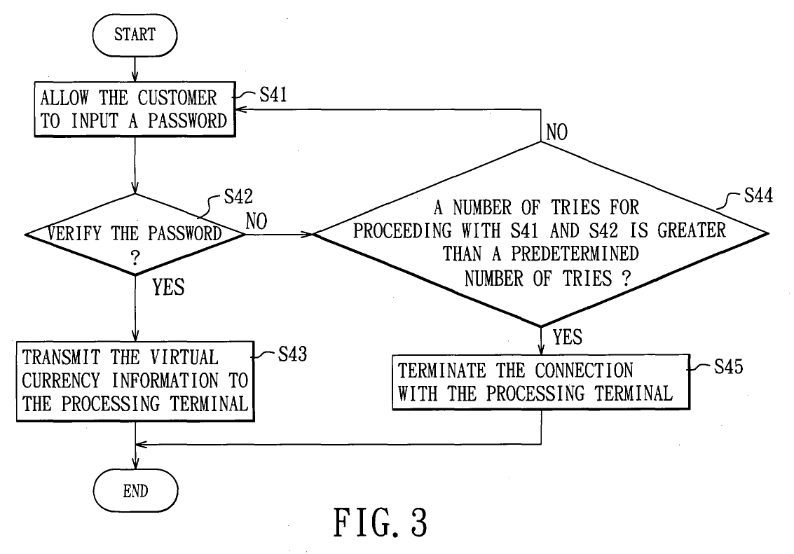

Referring to FIG. 3, there is shown a flow chart to illustrate how the mobile terminal 11 is configured to transmit the virtual currency information in accordance with the method of the preferred embodiment. In this embodiment, the mobile terminal 11 further includes a computer program product. In step S41, the computer program product configures the mobile terminal 11 to allow the customer 1 to input a password into the mobile terminal 11. In step S42, the computer program product configures the mobile terminal 11 to verify the password inputted by the customer 1. In step S43, upon detection of a successful verification result, the computer program product configures the mobile terminal 11 to transmit the virtual currency information to the processing terminal 21. In this embodiment, the mobile terminal 11 transmits the virtual currency information to the processing terminal 21 in an encrypted format. In step S44, upon detection of an unsuccessful verification result, the computer program product configures the mobile terminal 11 to verify whether a number of tries for proceeding with steps S41 and S42 is greater than a predetermined number of tries. The predetermined number of tries can be set to, for example, three. If no, steps S41 and S42 are repeated. In step S45, when the number of tries for proceeding with steps S41 and S42 is greater than the predetermined number of tries, the computer program product configures the mobile terminal 11 to terminate the connection with the processing terminal 21.

According to the method of this invention, the virtual currency information issued by the financial institution 3 and associated with a plastic currency, such as a credit card, a pre-paid card or a bank card, which belongs to the customer 1, can be stored in the mobile terminal 11. It is noted that the mobile terminal 11 can store the virtual currency information associated with more than one plastic currency such that the customer 1 can go shopping without carrying any plastic currency, thereby resulting in convenience during shopping. Moreover, the virtual currency information stored in the mobile terminal 11 can be transmitted to the processing terminal 21 in the encrypted format after password verification so as to ensure security during the monetary transaction. Decryption of the virtual currency information is performed by the financial institution 3 and not by the processing terminal 21 to further enhance security.

It is noted that the method of this invention is also applicable to virtual merchants, such as on-line shopping sites.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of making a monetary transaction between a customer and a merchant, comprising the steps of:
a) operating a processing terminal of the merchant to establish a connection with a mobile terminal of the customer and to request for virtual currency information issued by a financial institution and stored in the mobile terminal;
b) upon receipt of the virtual currency information from the mobile terminal, enabling the processing terminal to issue an authentication request to the financial institution; and
c) completing the monetary transaction upon receipt of an authorization response from the financial institution.

2. The method as claimed in claim 1, wherein the processing terminal is configured to establish a wireless communications link with the mobile terminal in step a).

3. The method as claimed in claim 2, wherein the processing terminal is configured to dial a telephone number associated with the mobile terminal in step a).

4. The method as claimed in Claim 1, wherein a transaction amount is inputted into the processing terminal in step a), and wherein the transaction amount is transmitted to the mobile terminal in step a).

5. The method as claimed in Claim 1, wherein a transaction amount is inputted into the processing terminal in step a), and wherein the transaction amount is transmitted to the financial institution in step b).

6. The method as claimed in claim 1, wherein step (c) includes generating a transaction receipt.

7. A method of making a monetary transaction between a customer and a merchant, comprising the steps of:
a) storing virtual currency information issued by a financial institution in a mobile terminal of the customer;
b) inputting transaction information into a processing terminal of the merchant;
c) enabling the processing terminal to establish a connection with the mobile terminal and to request for the virtual currency information stored in the mobile terminal;
d) enabling the mobile terminal to transmit the virtual currency information to the processing terminal upon receipt of the request from the processing terminal;
e) upon receipt of the virtual currency information from the mobile terminal, enabling the processing terminal to issue an authentication request to the financial institution;
f) enabling the financial institution to process the authentication request from the processing terminal and to issue an authorization response to the processing terminal in accordance with processing result of the authentication request; and
g) enabling the processing terminal to complete the monetary transaction upon receipt of the authorization response from the financial institution.

8. The method as claimed in claim 7, wherein the processing terminal is configured to establish a wireless communications link with the mobile terminal in step c).

9. The method as claimed in claim 8, wherein the processing terminal is configured to dial a telephone number associated with the mobile terminal in step c).

10. The method as claimed in claim 7, wherein the transaction information inputted in step b) includes a transaction amount, and where in the transaction amount is transmitted to the mobile terminal in step c).

11. The method as claimed in claim 7, wherein the transaction information inputted in step b) includes a transaction amount, and where in the transaction amount is transmitted to the financial institution in step e)

12. The method as claimed in claim 7, wherein step g) includes enabling the processing terminal to generate a transaction receipt.

13. The method as claimed in claim 7, wherein, in step d), the mobile terminal transmits the virtual currency information to the processing terminal in an encrypted format.

14. The method as claimed in claim 13, wherein step d) includes:
allowing the customer to input a password into the mobile terminal;
enabling the mobile terminal to verify the password inputted by the customer; and
upon detection of a successful verification result, enabling the mobile terminal to transmit the virtual currency information to the processing terminal in the encrypted format.
